(19) United States
(12) Patent Application Publication
(10) Pub. No.: US 2019/0385069 A1
(43) Pub. Date: Dec. 19, 2019

(54) NEARLINE UPDATES TO NETWORK-BASED RECOMMENDATIONS

(71) Applicant: Microsoft Technology Licensing, LLC, Redmond, WA (US)

(72) Inventors: Lingjie Weng, Sunnyvale, CA (US); Aastha Jain, Sunnyvale, CA (US); Hema Raghavan, Mountain View, CA (US); Mengda Yang, Sunnyvale, CA (US); Hongyi Zhang, Sunnyvale, CA (US); Hari Shankar Sreekumar Menon, Sunnyvale, CA (US); Shubham Gupta, San Mateo, CA (US); Parinkumar D. Shah, Milpitas, CA (US)

(73) Assignee: Microsoft Technology Licensing, LLC, Redmond, WA (US)

(21) Appl. No.: 16/007,342

(22) Filed: Jun. 13, 2018

(51) Int. Cl. G06N 5/04; G06Q 50/00; G06F 17/30; G06N 99/00

(52) U.S. Cl. CPC G06N 5/04; G06Q 50/01; G06F 17/3053; G06N 99/005; G06F 17/30374; G06F 17/30867

(57) ABSTRACT

The disclosed embodiments provide a system for processing data. During operation, the system retrieves, from a nearline data store, one or more updates representing recent activity for a member of an online network. Next, the system performs one or more queries using data in the updates to identify a set of candidates for recommending to the member. The system then applies one or more machine learning models to features for the set of candidates to generate a ranking of the set of candidates and updates the ranking based on additional features for an additional set of candidates from an offline data store. Finally, the system outputs, to the member, at least a portion of the updated ranking as connection recommendations in the online network.

### BACKGROUND

### Field

The disclosed embodiments relate to recommendation systems. More specifically, the disclosed embodiments relate to techniques for performing nearline updates to network-based recommendations.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, recruiters may use the online professional network to search for candidates for job opportunities and/or open positions. At the same time, job seekers may use the online professional network to enhance their professional reputations, conduct job searches, reach out to connections for job opportunities, and apply to job listings.

Moreover, the dynamics of online networks may shift as connections among users evolve. For example, a user may add connections within an online network over time. Each new connection may increase the user's interaction with certain parts of the online network and/or decrease the user's interaction with other parts of the online network. Consequently, use of online networks may be improved by mechanisms for characterizing and/or modulating the dynamics among users in the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a flowchart illustrating a process of generating a ranking of candidates as potential connections for a member in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

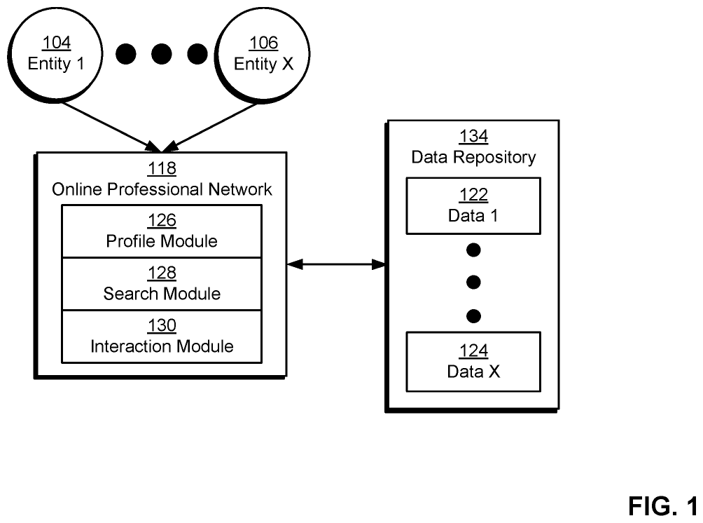

The disclosed embodiments provide a method, apparatus, and system for processing data. As shown in FIG. 1, the data may be associated with a user community, such as an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

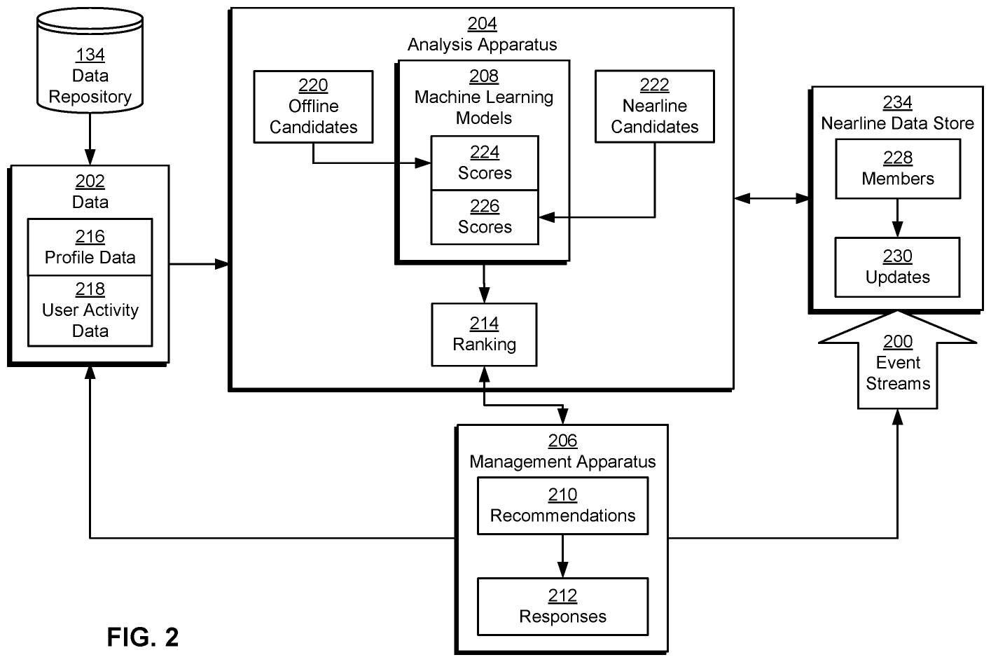

As shown in FIG. 2, data repository 134 and/or another primary data store may be queried for data 202 that includes profile data 216 for members of an online community (e.g., online professional network 118 of FIG. 1), as well as user activity data 218 that tracks the members' activity within and/or outside the online community. Profile data 216 includes data associated with member profiles in the online community. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the online community.

Attributes of the members from profile data 216 may be matched to a number of member segments, with each member segment containing a group of members that share one or more common attributes. For example, member segments in the online community may be defined to include members with the same industry, title, location, and/or language.

Connection information in profile data 216 may additionally be combined into a graph, with nodes in the graph representing entities (e.g., users, schools, companies, locations, etc.) in the online community. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 includes records of member interactions with one another and/or content associated with the online community. For example, user activity data 218 may track impressions, clicks, likes, dislikes, shares, hides, comments, posts, updates, conversions, and/or other user interaction with content in the online community. User activity data 218 may also track other types of activity, including connections, messages, and/or interaction with groups or events. Like profile data 216, user activity data 218 may be used to create a graph, with nodes in the graph representing online community members and/or content and edges between pairs of nodes indicating actions taken by members, such as creating or sharing articles or posts, sending messages, sending or accepting connection requests, joining groups, and/or following other entities.

In one or more embodiments, profile data 216 and/or user activity data 218 are used to generate a set of candidates in a matching or recommendation system. For example, data 202 in data repository 134 may be used with a “People You May Know” product in an online professional network (e.g., online professional network 118 of FIG. 1) and/or another community of users. The product may identify, for a given member of the community, additional members as potential connections in the community based on features or attributes such as connections in common between the member and the additional members and/or overlap in employment or education between the member and additional members. The product may also display and/or otherwise output the potential connections as recommendations 210 to the member (e.g., in a user interface, email, message, notification, etc.). In turn, the member may send connection invitations to potential connections he/she recognizes, thereby increasing the member's connectivity within and/or engagement with the online community.

An analysis apparatus 204 may obtain and/or produce a set of offline candidates 220 as potential recommendations 210 using data from a distributed filesystem and/or another offline data store providing data repository 134. Because generation of recommendations 210 from offline candidates 220 incurs multiple stages of delay, recommendations 210 produced from the offline data may fail to reflect recent activity from the member.

For example, a change to profile data 216 and/or user activity data 218 may be propagated over a number of minutes or hours to an eventually consistent graph database storing a graph-based representation of some or all profile data 216 and/or user activity data 218. Next, a delay of hours to days may be incurred during batch processing of data in the graph database to generate and/or rank a set of offline candidates 220. Further overhead may be required in subsequent loading of the ranked offline candidates 220 into a data store that can be queried for use in generating recommendations 210. Consequently, activity that is relevant to recommendations 210 may be reflected in recommendations 210 only after a significant delay (e.g., 1-2 days) when recommendations 210 are made using only offline data.

In one or more embodiments, the system of FIG. 2 includes functionality to supplement recommendations 210 of offline candidates 220 as potential connections with nearline candidates 222 that are identified using data from a nearline data store 234. Nearline data store 234 stores updates 230 representing recent activity from members 228 of the community. For example, updates 230 may include profile views, profile updates, connection invitations, new connections, job searches, job views, job applications, social gestures (e.g., likes, comments, shares, posts, etc.), and/or other member activity that is relevant to recommendations 210.

As shown in FIG. 2, data is received at nearline data store 234 over one or more event streams 200. For example, nearline data store 234 and/or a component for updating nearline data store 234 may subscribe to one or more event streams 200 containing records of user activity with the online community. Such event streams 200 may be generated and/or maintained using a distributed streaming platform such as Apache Kafka (Kafka™ is a registered trademark of the Apache Software Foundation). In turn, nearline data store 234 may receive events from event streams 200 on a nearline basis (e.g., after the events are generated in response to member activity).

Nearline data store 234 may then store data from events in event streams 200 for subsequent querying and/or retrieval by other components of the system. For example, an ingestion pipeline for nearline data store 234 may consume events from multiple event streams 200 and convert records transmitted in the events into updates 230 that adhere to a standardized format. Each update may identify a member, an action, and/or one or more attributes or features associated with the action (e.g., an identifier for a member, job, company, content item, and/or other entity to which the action is applied; a time of the action; a context of the action, etc.). The ingestion pipeline may also partition the standardized events by member identifiers for members 228 of the online community and store updates 230 in a number of storage nodes, with each storage node storing updates 230 for a subset of members 228. Within each storage node, a member identifier may be used as a key for retrieving updates 230 for the corresponding member that are written in reverse chronological order into one or more binary large objects (BLOBs).

When a trigger for generating or updating recommendations 210 for a member is received (e.g., when the member logs in to the community and/or interacts with a specific feature in the community), analysis apparatus 204 retrieves updates 230 representing recent activity for the member from nearline data store 234. For example, analysis apparatus 204 may include an identifier for the member in one or more queries of nearline data store 234. Nearline data store 234 may match the identifier to one or more BLOBs in a storage node containing data for the member. Nearline data store 234 may also use additional parameters of the queries (e.g., an activity type, a time interval associated with the member's activity, etc.) to retrieve new connections, connection invitations, profile updates, social gestures (e.g., shares, re-shares, comments, likes, etc.), content feed actions (e.g., views, clicks, etc.), job-seeking actions (e.g., job searches, job views, job applications, etc.), and/or other types of recent activity for the member. Nearline data store 234 may then transmit the data to analysis apparatus 204 in one or more responses to the queries.

Next, analysis apparatus 204 uses updates 230 for the member from nearline data store 234 to identify a set of nearline candidates 222 as potential connection recommendations 210 for the member. Each update may identify one or more entities affected by the corresponding activity, such as another member to which the member is newly connected, a job the member has viewed and/or submitted an application for, and/or a company or school that was added to the member's profile. In turn, analysis apparatus 204 may use the identified entities to retrieve members associated with the entities as nearline candidates 222.

For example, analysis apparatus 204 may identify one or more new connections of the member from updates 230, query data repository 134 and/or nearline data store 234 for connections of the new connections, and use the connections of the new connections as nearline candidates 222 that can be recommended as additional connections to the member. As a result, nearline candidates 222 may include members that form triadic closures in the online community. In another example, analysis apparatus 204 may identify a company with a job opening that the member recently viewed or applied to and use employees of the company as nearline candidates 222 for recommending to the member. Because nearline candidates 222 are identified based on updates 230 containing recent activity of the member (e.g., activity in the last few minutes to hours), nearline candidates 222 may differ from offline candidates 222 that are generated from older profile data 216 and/or user activity data 218 for the member.

Analysis apparatus 204 then uses features for offline candidates 220 and nearline candidates 222 as input into one or more machine learning models 208 to generate a set of scores 224 for offline candidates 220 and a different set of scores 226 for nearline candidates 222. For example, analysis apparatus 204 may apply weights, coefficients, and/or operations associated with machine learning models 208 to features associated with each offline and/or nearline candidate to produce a score representing the likelihood that the member will connect with the candidate after the candidate is outputted as a connection recommendation to the member.

Those skilled in the art will appreciate that different sets of features may be available for offline candidates 220 and nearline candidates 222. For example, offline candidates 220 may include a large number of features that are computed offline, such as a number of common connections between the member and a candidate, educational overlap between the member and the candidate, employment overlap between the member and a candidate, and/or a vector similarity (e.g., cosine similarity, Jaccard similarity, etc.) calculated from feature vectors of the member and the candidate. On the other hand, nearline candidates 222 may include features that are immediately queryable from data repository 134 and/or nearline data store 234, such as connections in common with the member and/or the context in which each nearline candidate was identified (e.g., a new connection of the member, a job view, a job application, a content feed interaction, etc.).

To account for differences in feature sets between offline candidates 220 and nearline candidates 222, analysis apparatus 204 uses different weights, coefficients, and/or operations associated with machine learning models 208 to generate scores 224 for offline candidates 220 and scores 226 for nearline candidates 222. For example, machine learning models 208 may include a joint and/or ensemble model that includes one or more logistic regression models, gradient boosted trees, random forest models, and/or other types of statistical models. In another example, machine learning models 208 may include one model for calculating scores 224 for offline candidates 220 and a different model for calculating scores 226 for nearline candidates 222. In both examples, machine learning models 208 may apply one set of weights, coefficients, and/or operations to features for offline candidates 220 to generate scores 224 and a different set of weights, coefficients, and/or operations to features for nearline candidates 222 to generate scores 226. Consequently, the way in which each set of scores 224-226 is produced may reflect the availability, type, and/or importance of the corresponding features in predicting the likelihood of a connection between the member and each candidate.

After both sets of scores 224-226 are produced, analysis apparatus 204 generates a ranking 214 of offline candidates 220 and nearline candidates 222 by the corresponding scores 224-226. For example, analysis apparatus 204 may rank offline candidates 220 and nearline candidates 222 by descending score, so that candidates with the highest chance of connecting with the member are at the top of ranking 214 and candidates with a lower chance of connecting with the member are lower in ranking 214.

Management apparatus 206 then outputs some or all candidates in ranking 214 as recommendations 210 to the member. For example, management apparatus 206 may display a list and/or other representation of ranking 214 to the member within the “People You May Know” feature or module of the online community. Management apparatus 206 may also, or instead, transmit an email, notification, text message, and/or other communication containing one or more candidates in ranking 214 to the member.

Management apparatus 206 and/or another component of the system may also, or instead, automatically apply changes to the member's connections and/or connection invitations based on scores 226 and/or ranking 214. For example, the component may automatically send connection invitations from the member to a highest-ranked subset of candidates in ranking 214 and/or a subset of candidates with scores 226 that exceed a threshold. In another example, the component may automatically add the member as a follower of the identified candidates. The component may optionally generate a notification, email, message, or other communication requesting that the member confirm his/her relationships with each candidate before performing the automatic change.

Management apparatus 206 and/or another component of the system further tracks one or more responses 212 of the member to the outputted recommendations 210. For example, the member may have the option of accepting, rejecting, or ignoring a connection recommendation. When the member accepts, rejects, or ignores a given recommendation, the component may emit an event containing the response of the member to the recommendation, identifiers for the member and the candidate in the recommendation, a timestamp of the response, and/or other data. In turn, the event may be received at nearline data store 234, included in updates 230 for the member, and subsequently used to identify additional nearline candidates 222 for the member and/or modulate ranking 214 or recommendations 210.

Analysis apparatus 204 and/or management apparatus 206 may also adjust scores 224-226 and/or ranking 214 based on the number of times the member has previously viewed a candidate (e.g., in previous sets of recommendations 210 to the member). For example, analysis apparatus 204 and/or management apparatus 206 may decrease a candidate's score and/or position in ranking 214 as the member's views of the candidate as a connection recommendation increase. In other words, the system of FIG. 2 may perform impression discounting of recommendations 210.

By generating connection recommendations 210 from both offline candidates 220 and nearline candidates 222, the system of FIG. 2 may improve the timeliness, quantity, and/or quality of recommendations 210. Such recommendations 210 may increase the member's connectivity in the online community, engagement with the online community, the value of the member to the online community, and/or the value of the online community to the member. Consequently, the system may improve technologies related to use of online networks through network-enabled devices and/or applications, as well as user engagement and interaction through the online networks, network-enabled devices, and/or applications.

Those skilled in the art will appreciate that the system of FIG. 2 may be implemented in a variety of ways. First, analysis apparatus 204, management apparatus 206, data repository 134, and/or nearline data store 234 may be provided by a single physical machine, multiple computer systems, one or more virtual machines, a grid, one or more databases, one or more filesystems, and/or a cloud computing system. Analysis apparatus 204 and management apparatus 206 may additionally be implemented together and/or separately by one or more hardware and/or software components and/or layers.

Second, a number of machine learning models 208 and/or techniques may be used to generate scores 224-226 and/or ranking 214. For example, each machine learning model may be a logistic regression model, Poisson regression model, artificial neural network, support vector machine, decision tree, naïve Bayes classifier, Bayesian network, clustering technique, hierarchical model, and/or ensemble model. The same machine learning model and/or different machine learning models may be used to calculate scores 224-226 for offline candidates 220 and nearline candidates 222.

Third, scores 224-226 may be generated in various ways. For example, scores 224 for offline candidates 220 may be generated on an offline basis, while scores 226 for nearline candidates 222 may be generated on a nearline basis (e.g., after nearline candidates 222 are identified). Scores 224-226 may additionally represent and/or reflect various attributes, such as the likelihood of a connection between the member and each candidate, a change in activity level of the member and/or candidate in the community given the connection, and/or the value of the connection to each member and/or the community.

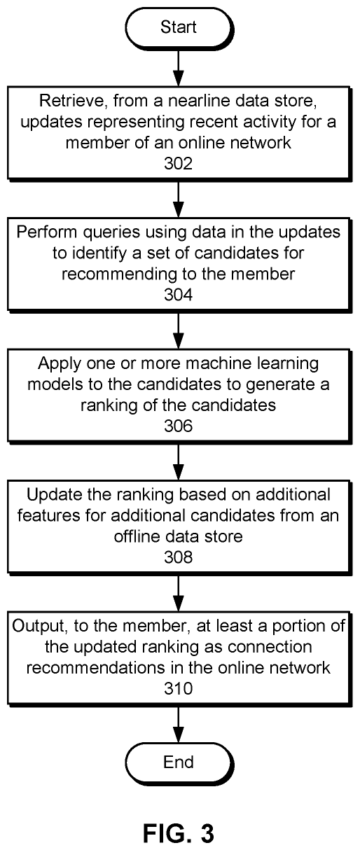

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, updates representing recent activity for a member of an online network are retrieved from a nearline data store (operation 302). The updates may be stored in the nearline data store based on events containing records of recent activity in the online network. For example, the events may be received over an event stream on a nearline basis, and records from events associated with a given member may be stored in reverse chronological order within one or more BLOBs in the nearline data store. Updates for the member may then be retrieved from the nearline data store after the member accesses the online network and/or may be based on another trigger.

Next, queries are performed using data in the updates to identify a set of candidates for recommending to the member (operation 304). For example, the data may be used to identify a set of entities related to the updates, and the set of entities may be included in queries that retrieve the candidates from another data store (e.g., an offline data store). The entities may include new connections of the member, a company, and/or a job. In turn, the candidates may include connections of the new connection, employees of the company, and/or members with the same job or similar jobs.

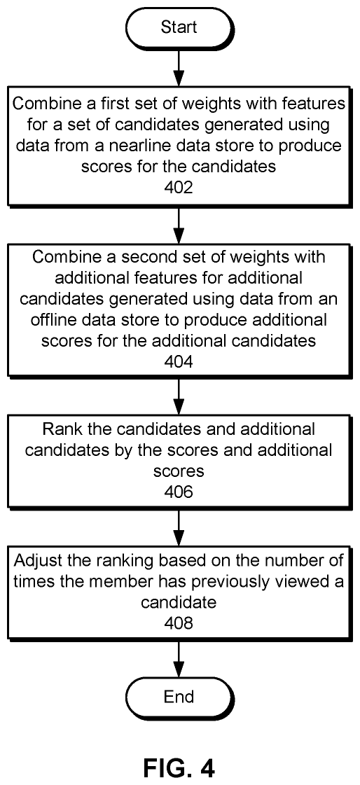

One or more machine learning models are then applied to the candidates to generate a ranking of the candidates (operation 306), and the ranking is updated based on additional features for additional candidates from an offline data store (operation 308). Generating rankings of candidates from nearline and/or offline data stores is described in further detail below with respect to FIG. 4.

Finally, at least a portion of the updated ranking is outputted to the member as connection recommendations in the online network (operation 310). For example, the highest ranked candidates may be shown in a list, grid, and/or other representation to the member when the member accesses the online network; in an email, message, or notification to the member; and/or in another form of communication with the member.

FIG. 4 shows a flowchart illustrating a process of generating a ranking of candidates as potential connections for a member in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, a first set of weights is combined with features for a set of candidates generated using data from a nearline data store to produce scores for the candidates (operation 402). For example, the weights may include coefficients from a logistic regression model that are combined with features such as a number of common connections between each candidate and the member and/or a context associated with each candidate. Each score may represent the probability of a connection between the member and a given candidate, given a recommendation of the candidate as a potential connection to the member.

Next, a second set of weights is combined with additional features for additional candidates generated using data from an offline data store to produce additional scores for the additional candidates (operation 404). Continuing with the previous example, the second set of weights may include different coefficients from the same logistic regression model and/or a set of coefficients from a different logistic regression model. The weights may be combined with features such as a number of common connections between the member and a candidate, educational overlap between the member and the candidate (e.g., overlap in attendance at the same school), employment overlap between the member and the candidate (e.g., overlap in positions at the same company), and/or a similarity between the member and the candidate (e.g., a vector similarity calculated from feature vectors for the member and the candidate). Like scores produced in operation 402, each score calculated in operation 404 may represent the probability of a connection between the member and a given candidate, given a recommendation of the candidate as a potential connection to the member.

The candidates and additional candidates are then ranked by the scores and additional scores (operation 406). For example, both sets of candidates may be combined into the same ranking, with candidates in the ranking ordered by descending score.

The ranking may also be adjusted based on the number of times the member has previously viewed a candidate (operation 408). For example, a candidate's score and/or position in the ranking may be lowered as the number of times the member has viewed the candidate as a recommendation increases. The ranking may also, or instead, be updated to reflect a certain number or proportion of offline candidates and/or nearline candidates, the preferences or behavior of the member, and/or other attributes.

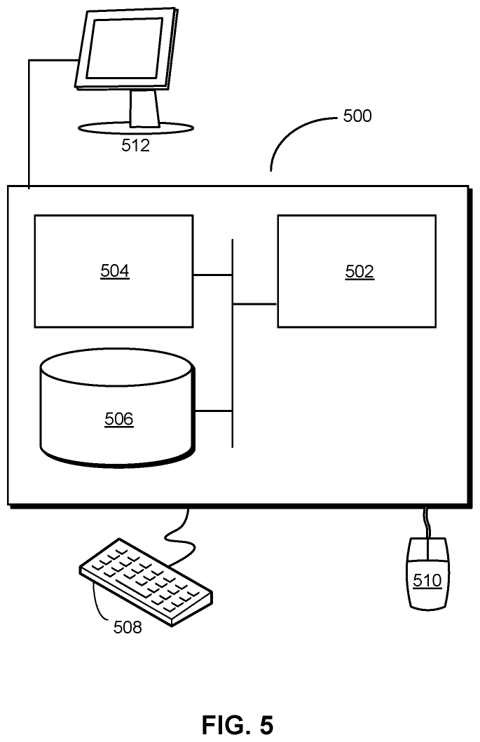

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system includes an analysis apparatus and a management apparatus, one or both of which may alternatively be termed or implemented as a module, mechanism, or other type of system component. The analysis apparatus retrieves, from a nearline data store, one or more updates representing recent activity for a member of an online network. Next, the analysis apparatus performs one or more queries using data in the updates to identify a set of candidates for recommending to the member. The analysis apparatus then applies one or more machine learning models to features for the set of candidates to generate a ranking of the set of candidates and updates the ranking based on additional features for an additional set of candidates from an offline data store. Finally, the management apparatus outputs, to the member, at least a portion of the updated ranking as connection recommendations in the online network.

In addition, one or more components of computer system 500 may be remotely located and connected to the other components over a network. Portions of the present embodiments (e.g., analysis apparatus, management apparatus, data repository, nearline data store, online professional network, etc.) may also be located on different nodes of a distributed system that implements the embodiments. For example, the present embodiments may be implemented using a cloud computing system that recommends potential connections to a set of remote members of an online network.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
retrieving, from a nearline data store, one or more updates representing recent activity for a member of an online network;
performing, by one or more computer systems, one or more queries using data in the one or more updates to identify a set of candidates for recommending to the member;
applying, by the one or more computer systems, one or more machine learning models to features for the set of candidates to generate a ranking of the set of candidates;
updating the ranking based on additional features for an additional set of candidates from an offline data store; and
outputting, to the member, at least a portion of the updated ranking as connection recommendations in the online network.

2. The method of claim 1, further comprising:
storing the updates in the nearline data store based on events comprising records of recent activity in the online network.

3. The method of claim 2, wherein storing the updates in the nearline data store based on the events comprises:
storing, in the nearline data store, a subset of the records for a given member in reverse chronological order.

4. The method of claim 1, wherein identifying the set of candidates for recommending to the member based on the one or more updates comprises:
identifying a set of entities related to the updates; and
using the set of entities to retrieve the set of candidates from another data store.

5. The method of claim 4, wherein the set of entities comprises at least one of:
a new connection of the member in the online network;
a company; and
a job.

6. The method of claim 5, wherein the set of candidates comprises a set of connections of the member.

7. The method of claim 1, wherein the features and the additional features comprise at least one of:
a number of common connections between the member and a candidate;
educational overlap between the member and the candidate;
employment overlap between the member and the candidate; and
a similarity between the member and the candidate.

8. The method of claim 1, wherein applying the one or more machine learning models to the set of candidates to generate the ranking of the set of candidates comprises:
combining a first set of weights with the features to produce a set of scores for the set of candidates; and
ranking the set of candidates by the set of scores.

9. The method of claim 8, wherein updating the ranking based on the additional features for the additional set of candidates comprises:
combining a second set of weights with the additional features to produce an additional set of scores for the additional set of candidates; and
ranking the set of candidates and the additional set of candidates by the set of scores and the additional set of scores.

10. The method of claim 8, wherein the set of scores comprise a probability of a connection between a member and a candidate in the set of candidates.

11. The method of claim 1, wherein updating the ranking with the additional set of candidates comprises:
adjusting the ranking based on a number of times the member has previously viewed a candidate.

12. The method of claim 1, wherein the recent activity comprises at least one of:
a social gesture;
a profile action;
a content feed action; and
a job-seeking action.

13. The method of claim 1, wherein the one or more updates comprise a new connection between the member and another member of the online network.

14. A system, comprising:
one or more processors; and
memory storing instructions that, when executed by the one or more processors, cause the system to:
retrieve, from a nearline data store, one or more updates representing recent activity for a member of an online network;
perform one or more queries using data in the one or more updates to identify a set of candidates for recommending to the member;
apply one or more machine learning models to features for the set of candidates to generate a ranking of the set of candidates;
update the ranking based on additional features for an additional set of candidates from an offline data store; and
output, to the member, at least a portion of the updated ranking as connection recommendations in the online network.

15. The system of claim 14, wherein identifying the set of candidates for recommending to the member based on the one or more updates comprises:
identifying a set of entities related to the updates; and
using the set of entities to retrieve the set of candidates from another data store.

16. The system of claim 14, wherein the features and the additional features comprise at least one of:
a number of common connections between the member and a candidate;
educational overlap between the member and the candidate;
employment overlap between the member and the candidate; and
a similarity between the member and the candidate.

17. The system of claim 14, wherein applying the one or more machine learning models to the set of candidates to generate the ranking of the set of candidates comprises:
combining a first set of weights with the features to produce a set of scores for the set of candidates; and
combining a second set of weights with the additional features to produce an additional set of scores for the additional set of candidates; and
ranking the set of candidates and the additional set of candidates by the set of scores and the additional set of scores.

18. The system of claim 14, wherein the recent activity comprises at least one of:
a social gesture;
a profile action;
a content feed action; and
a job-seeking action.

19. The system of claim 14, wherein the one or more updates comprise a new connection between the member and another member of the online network.

20. A non-transitory computer-readable storage medium storing instructions that when executed by a computer cause the computer to perform a method, the method comprising:
retrieving, from a nearline data store, one or more updates representing recent activity for a member of an online network;
performing one or more queries using data in the one or more updates to identify a set of candidates for recommending to the member;
applying one or more machine learning models to features for the set of candidates to generate a ranking of the set of candidates;
updating the ranking based on additional features for an additional set of candidates from an offline data store; and
outputting, to the member, at least a portion of the updated ranking as connection recommendations in the online network.
